(19) United States
(12) Patent Application Publication
(10) Pub. No.: US 2017/0239136 A1
(43) Pub. Date: Aug. 24, 2017

(54) Sound Infusion Device and Method

(71) Applicant: Mark Reader, Freeland, WA (US)

(72) Inventor: Mark Reader, Freeland, WA (US)

(21) Appl. No.: 15/438,713

(22) Filed: Feb. 21, 2017

Related U.S. Application Data
(60) Provisional application No. 62/297,141, filed on Feb. 19, 2016.

(51) Int. Cl. A61H 23/02

(52) U.S. Cl. CPC A61H 23/02; A61H 2201/1207; A61H 2201/5023

(57) ABSTRACT

A system for delivering harmonic frequency by direct contact for therapeutic purposes for the treatment of tissue, such as hard and soft tissue, muscles, nerves, and scar tissue. The apparatus uses a sound infusion table and optionally smaller pads with a sound amplifier to flexibly treat the whole body or a specific site in a non-invasive manner. The system, delivers harmonic frequency to the body or a specific location through direct contact with the body or specific locations, such as joints, feet, lungs, and thighs.

### CROSS-REFERENCE TO RELATED APPLICATIONS

The present application is a nonprovisional application which claims the benefit of U.S. Provisional Patent Application No. 62/297,141, filed on Feb. 19, 2016, entitled “Sound Infusion Device & Method,” which is incorporated herein by reference in its entirety as if fully set forth herein.

### FIELD OF THE DISCLOSURE

This disclosure relates generally to the field of the treatment of tissue, such as hard and soft tissue, muscles, nerves, and scar tissue.

### BACKGROUND

There are a variety of known methods for the treatment of tissue. These methods include wound dressings, hyperbaric oxygen treatment, growth factor therapy, antibiotics, surgery, physical therapy, vacuum therapy, electrical simulation, bioengineered tissue, ultraviolet light therapy, and tissue ultrasound. It is also well known to provide humans and animals with vibrational therapy through massage chairs, hand massagers, whole body vibration plates, handheld lasers or similar apparatuses that are applied to different parts of the body, sometimes with or without heat. These devices have served to relax the individual by stimulating the nervous system and promoting blood flow and increased oxygen to a particular part of the body to help with conditions and areas such as anxiety, post-operative healing, athletic and general performance, pain, aging, injuries, obesity, and general health.

Some treatments, such as described in U.S. Pat. No. 8,956,314, treat the symptom by blocking pain without healing the underlying problem or provide a long-term solution. While other treatments, such as in U.S. Pat. No. 6,061,597, may comprise hours of treatment five days a week until healed, taking up a large part of a patient's time and take a while to heal. Treatments described in U.S. Pat. No. 7,431,704 involve “fragmentation and simultaneous sonication of a treatment area,” which requires direct contact with the problem area and is invasive.

For the foregoing reasons, a device and method that is non-invasive, promotes healing, and requires minimal treatment time in duration and number of sessions would be very useful to a wide spectrum of users, primarily anyone that may need therapeutic treatment of tissue.

Accordingly, a device and method is disclosed, which includes a table or pad, a speaker or wire wrap, and a control box.

### SUMMARY

The present invention relates to a device and method comprising a table or pad; a speaker or wire wrap; and a control box.

The disclosed invention comprises a sound table or pad that delivers harmonic frequency by direct contact with tissue, such as hard and soft tissue, muscles, nerves, and scar tissue. The methods and apparatuses of the present invention are desirable because they are designed for flexibility in treating the whole body or a specific site, non-invasive, and requires a minimal duration in treatment session and number of treatment sessions.

The following embodiments and descriptions are for illustrative purposes only and are not intended to limit the scope of the Sound Infusion Device and Method. Other aspects and advantages of the present disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 is a diagram of a sound table.

FIG. 2 is a diagram of a sound table with a speaker embodiment.

FIG. 3 is a diagram of a sound table with a wire wrap embodiment.

FIG. 4 is a diagram of a control box.

FIG. 5 is an isometric view of the control box from multiple angles.

FIG. 6 is a diagram illustrating electron infusion.

FIG. 7 is a diagram illustrating the single channel circuitry of control box 1.

FIG. 8 is a diagram illustrating a first dual channel circuitry of control box 2.

FIG. 9 is a diagram illustrating a second dual channel circuitry of control box 2.

FIG. 10 is a diagram illustrating the circuitry of control box 3.

These figures are all arranged in accordance with at least some embodiments of the present disclosure.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number),” this means a range whose limit is the second number. For example, 25 to 100 mm means a range whose lower limit is 25 mm and upper limit is 100 mm.

### Definitions

Labradorite (Black Galaxy): a mineral of the plagioclase feldspar group, found in many igneous rocks.

Blue Larvikite: A blue-hued igneous rock, specifically a variety of monzonite, notable for the presence of handsome, thumbnail-sized crystals of feldspar.

Biotite (black Mica): A complex silicate containing potassium, magnesium, iron, and aluminum.

Black Galaxy Granite: also known as Black Ametist, Black Ametista, Black Amethist, black Amethyssta, Black and Gold, Black galaxi, Black Galaxy Granite, Black Gold Sands, Ga. 902, Galaxi Black, Galaxy Black, Galaxy Gold, GalaxyGold, Galaxy Star, Nero Ametista, Nero Galassia, Nero Galaxy, Nero Star Galaxi, Nero Star Galaxi, Nero Star Galaxy, Star Galaxi, Star Galaxy Black, Star Galaxy Granite, Star Galiaxy, WG203: A fine to medium-grained, black gabbro of the Precambrian period with golden-yellow sparkling bronzite scales. This stone internationally may be nominated as a granite however in areas of application of the European Standard (EN) this stone must be nominated as gabbro. The quarrying area is Chimakurthi, Ongole, Andhra Praesh, South India.

Bronzite. An iron bearing Pyroxene mineral. Iron, magnesium, oxygen, and silica can be found in bronzite.

Cation: A positively charged ion.

Gabbro: A dark-colored, coarse-grained intrusive igneous rock. Gabbro is very similar to basalt in its mineral make up. It is composed mostly of the mineral plagioclase feldspar with smaller amounts of pyroxene and olivine.

Feldspar Group: a group of rock-forming tectosilicate minerals that make up as much as 60% of the Earth's crust. Feldspars crystallize from magma as veins in both intrusive and extrusive igneous rocks and are also present in many types of metamorphic rock. Rock formed almost entirely of calcic plagioclase feldspar is known as anorthosite. Feldspars are also found in many types of sedimentary rocks.

Free Radical: An especially reactive atom or group of atoms that have one or more unpaired electrons, especially one that is produced in the body's natural biological processes or induced by external factors (such as tobacco, toxins, and pollutants) that can damage cells, proteins, and deoxyribonucleic acid (DNA) by altering their chemical structure. Free radicals are known to be the major contributor to aging.

Frequency: the number of occurrences of a repeating event per unit time. An important parameter used in science and engineering to specify the rate of oscillatory and vibratory phenomena, such as mechanical vibrations, audio (sound) signals, radio waves, and light.

General Healing Frequency: 528 Hz is a chord of the same perfect harmony of the universe and has been proven to create healing vibrations for the mind, body, and spirit. The science of biophysics, electrogenics, and a little known science as “symatics” best explains the bioenergetics/bioacoustics foundation of organic chemistry, DNA, and all biological forms and functions. All matter is resonated into shape by “core creative frequencies” at the heart of which is 528 nanometers (nm) of light. These vibrations cause atoms and molecules to “flow” into shapes most common in nature. Snowflakes and honeycombs are good examples. All biological life forms and functions are likewise celebrations of the 528 sound and light frequency. The shape of carbon-6 and the hexagonal ring to organic chemistry is another example of 528 expressed in all life forms. This frequency is known to produce electron-rich oxygen that is widely known for its healing power.

Gray Pearl Larvikite: A gray pearl hued igneous rock, specifically a variety of monzonite, notable for the presence of handsome, thumbnail-sized crystals of feldspar.

Harmonic Frequency: The multiple of a fundamental frequency. A fundamental frequency of 500 Hz would have a first harmonic of 1000 Hz, double the first harmonic. The second harmonic would be 1500 Hz, the third harmonic would be 2000 Hz, and so on.

Hertz (Hz): the unit of frequency in the International System of Units (SI) and is defined as one cycle per second. One of the unit's most common uses is in the description of sine waves and musical tones, particularly those used in radio and other audio-related applications.

Carrara Marble (Italian Marble): is a type of white or blue-grey marble of high quality, popular for use in sculpture and building decor.

Labradorite: a feldspar mineral, is an intermediate to calcic member of the plagioclase series. It has an anorthite percentage of between 50 and 70. The specific gravity ranges from 2.68 to 2.72. The streak is white, like most silicates. The refractive index ranges from 1.559 to 1.573. Twinning is common. As with all plagioclase members, the crystal system is triclinic, and three directions of cleavage are present, two of which form nearly right angle prisms. It occurs as clear, white to gray, blocky to lath shaped grains in common mafic igneous rocks such as basalt and gabbro, as well as in anorthosites.

Larvikite: an igneous rock, specifically a variety of monzonite, notable for the presence of handsome, thumbnail-sized crystals of feldspar. These feldspars are known as ternary because they contain significant components of all three end-member feldspars. The feldspar has partly unmixed on the micro-scale to form a perthite, and the presence of the alternating alkali feldspar and plagioclase layers give its characteristic silver blue sheen (Schiller effect, labradorescence) on polished surfaces. Olivine can be present along with apatite, and locally quartz. Larvikite is usually rich in titanium, with titanaugite and/or titanomagnetite present. Larvikite occurs in the Larvik Batholith (a.k.a. Larvik Plutonic Complex), a suite of 10 igneous plutons emplaced in the Oslo Rift (Oslo Graben) surrounded by ˜1.1 billion year old Sveconorwegian gneisses. The Larvik Batholith is of Permian age, about 292-298 million years old. Larvikite is also found in the Killala Lake Alkalic Rock Complex near Thunder Bay in Ontario, Canada. The name originates from the town of Larvik in Norway, where this type of igneous rock is found.

MgO: Magnesium oxide

Muscovite (white Mica): A complex silicate containing potassium and aluminum.

Olivine: Silicate of magnesium and iron (MgFe)2SiO4.

Orthoclase (Potassium Feldspar): Potassium-aluminum silicate.

Pain Level: On a scale of zero to ten, zero equals no pain and ten is maximum pain (screaming pain).

Plagioclase: A mineral with a specific chemical composition known as feldspar.

Plagioclase Feldspar: Sodium-calcium-aluminum silicates.

Pyroxene: A silicate containing chiefly calcium and magnesium; also varying amounts of aluminum, iron, and sodium.

Quartz: Silicon dioxide, SiO2.

Silver Sea Green Granite: Also known as Emerald green, Blue-Green, Ranyah Green, Green Ranyah, Rania Green, Ranyah Emerald, Saudi Green, Oriental Green. This granite is quarried near Ranyah, Saudi Arabia and is known as the hardest granite around. This granite weathers at less than 0.125″ per 1,000 years and is sanitary and stain resistant. Silver Sea Green Granite is a medium-grained, grey-green granite with black flecks of the Precambrian period. Silver Sea Green Granite from Saudi Arabia with a speaker embodiment has been known to disintegrate Settling within the striations of the muscle.

Smaller Devices: another term used for sound infusion pads.

Sound Infusion Pads: a smaller embodiment of the device described herein that is smaller in size to treat portions of the body, such as ears, feet, thigh, joint, or lung (may be human or animal). Size and shape may vary to fit the need.

Sound Infusion Table: a large embodiment of the device described herein that is large enough in size to treat the entire body (may be human or animal). Size and shape may vary to fit the need.

The present disclosure is generally drawn, inter alia, to a device and method relating to therapeutic treatment of tissue, such as hard and soft tissue, muscles, nerves, and scar tissue, by delivering harmonic frequency by direct contact with tissue. In some examples, the sound infusion table and pads deliver harmonic frequency to the body or a specific location through direct contact with the body or specific locations, such as joints, feet, lungs, and thighs.

Basic frequency requirements for organ repair may be 100 Hz. through 750 Hz. Introducing the resonant frequency for an individual organ may cause that organ to regain its original resonance and retain that resonance due to memory and begin healing by oxygenation from a 528 Hz. signal. Organ frequencies are as follows and listed in Hertz and sine wave; Blood 321.9, Adrenals 492.8, Kidney 319.88, Liver 317.83, Bladder 352, Intestines 281, Lungs 220, Colon 176, Gall Bladder 164.3, Pancreas 117.3, Stomach 110, Brain 315.8, Fat Cells 295.8, Muscles 324, Bone 418.3, and the general healing frequency of 528 for oxygenation and acid buffering. Although, frequencies from 0.01 Hz. through 1000 Hz. may be utilized for other purposes, such as mind expansion at 8 Hz. and mood control at higher frequencies, such as 936 Hz. for Pineal Gland activity for melatonin production.

Before treatment begins, the patient undergoes physical and psychological tests including, severity of injury, range of motion, pain area(s), pain level(s), oxygen level, heart rate and pressure, and whether the patient has medical documentation for the ailment to be addressed. A standardized psychological test may be performed to determine level of depression to assure stability and if the patient should seek professional help. Testing also determines which method to use based on the user's comfort level with the physical embodiments and systems such as the speaker embodiment or wire wrap embodiment. The 528 Hz. frequency crystalizes the blood to prevent coagulation and plaque buildup in the veins and to promote blood flow. It is unknown if the 528 Hz. signal would disintegrate or dislodge blood clots, causing further problems in a patient that has been diagnosed with a clot. Patients diagnosed with one or more blood clots may be dismissed from any sound infusion treatment until further studies have been conducted. It is also unknown if this device will disrupt the operation of cardiac pacemakers.

The first step is to prepare the Sound Infusion Table by wiping it with isopropyl alcohol (minimum 91%) or cover the table with standard exam table paper or perhaps comparable 1 or 2 millimeter plastic for medical use. Assure power is applied by checking the power “on” light, the frequency is set at 528 Hz. and voltage used on the table via the control box will be preset by the manufacturer to assure patient safety.

The next major step is to help the patient on to the sound infusion table device. The patient is to lay with their back on the table slab (shirt, pants and socks on, no shoes), knees together and bent in an upward position creating the “pelvic tilt” position on the table, with feet flat on slab (one foot in each corner), head on a small pillow for comfort and arms at the patient's sides, hands to be palms down on table. Alternative position would be to use a larger embodiment where the patient would lay flat on their back and stretched out on the table to eliminate the “pelvic tilt” position allowing the leg muscles to be in contact with the table, which also allows the lower extremities to receive full benefit of the signal for such problems as myalgia from immobility.

The treatment starts at the time of contact with the table producing the 528 Hz. frequency. It has been noted that, intuitively, patients feel 20 minutes with the speaker embodiment works well for complete pain relief. In general, one treatment is enough for minor muscular pain problems. More severe muscular pain may require more treatments, as for myalgia or chronic pain. Treatment may consist of 20 minutes or less treatment sessions every other day for 1 week, with a follow up of 2 treatments the next week at 20 minutes or less treatment sessions, then once a week for 20 minutes or less treatment sessions, if needed.

If the wire wrap open loop embodiment is used, the treatment sessions would be reduced to 10 or 15 minutes. Some patients report light-headedness for approximately 1-2 minutes after treatment, and body feeling very light. This is a possible indicator of oxygenation. Also, reports of fog in the brain caused by medication disappears, clearer thinking, relaxed but very aware. Depression and anxiety reduce or disappear for several days after treatment. There are reports of a deeper sleep after treatment. Possible erasure with respect to chronic pain tracks in the mind from past pain signals from an area that no longer needs repair, old issues may come up from the conscious mind to be dealt with in a positive and logical thought process and solved or discarded as irrelevant leaving that path free for other processing. Possible accelerated plasticity of the mind. No adverse psychological effects have been observed. In general, pain relief from the Sound Infusion Table use is one day to one week for some chronic pain and immobility. Some patients experience pain relief after one treatment and need no further sessions, this is a possible indication of inflammation reduction, increased blood flow and healing from oxygenation.

A maintenance treatment session of once a week to once a month may be advantageous to reduce inflammation due to environment and food intake. Treatments on this sound infusion table have shown to eliminate head-aches, reduce head and chest congestion from flu and colds. Possible COPD (Chronic Obstructive Pulmonary Disease) reversal with a longer time frame for treatments. Severe cases of back pain or congestion may require daily treatments until relief is achieved, then tapering off to standard treatments as above

The Sound Infusion Battery Operated Mobile Device is designed to be used with self-adhesive body electrode pads such as ECG, EKG pads or Tens unit pads. The 528 Hz sine wave signal from this device is designed to be delivered by means of direct electrode contact with problem areas, such as muscle strains, spasms, or knots. Pain has been noted to be totally relieved within 2 to 10 minutes with this device. Joint pain may also be reduced, and an increase of approximately 50% bladder control in incontinent patients in one treatment.

If needed, the Battery Operated Mobile device may be used within a schedule structure such as the treatment and maintenance on the Sound Infusion Table described above. Treatment time with this device is designed to be 10-minute sessions. To operate the device, the unit may be turned on with the power switch and the red indicator light will activate. If the indicator light is not on, then turn the power switch off and recharge the unit with the provided battery charger only. When the green light is showing on the charger, the unit will be charged. The electrode may then be placed on a patient's problem area, turn unit on, if the red indicator light is on then push the momentary start button to start the signal, a green indicator light will be seen, the 528 Hz signal is now being administered to the patient. This unit is designed to shut the signal down in 10 minutes but not the main power, main power is a manual function. If more time is needed, the signal start button may be pushed again for another 10-minute session or terminate signal prematurely by moving the main power switch to the “OFF” position. The main power should be OFF before removing the electrode from the patient.

Most patients experience pain relief in 10 to 20 minutes on the sound infusion table and the smaller devices in one session.

The smaller devices may be placed near an organ or muscle that needs repair. Organ treatments would not need more than several minutes of the organ's resonant frequency signal for acclamation, then followed up with the standard 528 Hz treatment and maintenance schedule as in the aforementioned table or small device usage for possible complete healing.

In addition to the above mentioned methods, performing an additional treatment for 10 to 20 minutes in between scheduled sessions may increase the healing process depending on severity, such as in cases of neuropathy or myalgia.

More severe pain problems may require several 20 minute sessions for one to two weeks with a following week of 10 minute sessions with possible once-a-week follow-up sessions. It is noted that less time is needed on the table as the sessions continue.

The sound infusion table and pads may be configured to operate with the speaker embodiment or open loop wire wrap embodiment or running both embodiments at the same time.

Frequencies from 0.01 Hz. to 1000 Hz. may be utilized with the 110 VAC units for individual organ resonance for repair. The hand held control unit may be modified to produce other frequencies as well. These devices were developed for pain relief with a 528 Hz. sine wave; other healing that happens may possibly be considered as side effects of the devices.

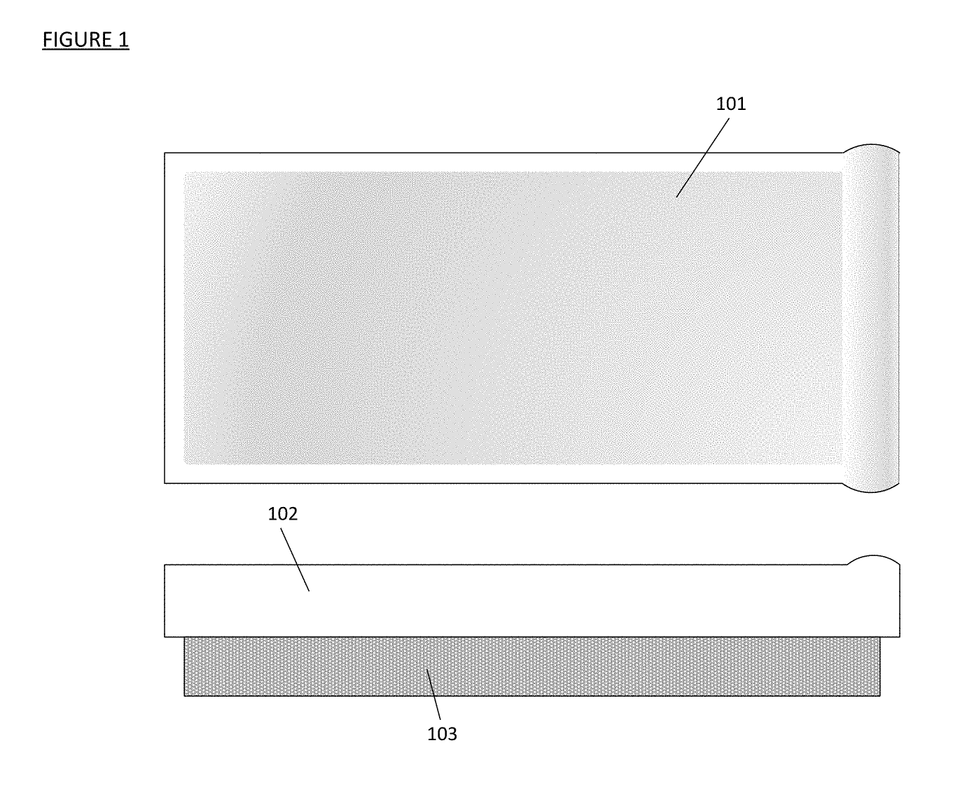

Referring now specifically to FIG. 1, the figure is a diagram of a sound table. FIG. 1 has a stone slab 101, a border 102, and a base 103. Stone slab 101 is a slab of stone material that serves as a medium to transfer the signal from a speaker and/or an open loop wire wrap to tissue in direct contact with the stone material. Border 102 is material that surrounds and supports stone slab 101. Border 102 serves to aesthetically hide any speaker, wiring, and control box and to functionally provide a headrest and prevent harm to stone slab 101 and users. Base 103 is simply a base for the table to rest on and adjust the height for ease of use.

Stone slab 101 is may have dimensions in the range of 2′×4′×1⅛″ to 30″ ×7′×1⅛″. The dimensions of the stone slab 101 may also be any general shape and vary in size and dimensions to accommodate both human patients and animals. For smaller devices, such as with the sound infusion pads, stone slab 101 may have dimensions that is approximately 6″×14″×¾″ or be any general shape for deep vein thrombosis of the thigh muscle from immobility or overuse. The sound infusion pad may have dimensions that is approximately 11″×12″×¾″ or have any general shape for foot neuropathy. The sound infusion pad use the same design as the sound infusion table with a resonator with the exception of the speaker location, which will be mounted flush to the slab of stone with no offset. The same design may be used with round stone slabs having a 3″ to 4″×¼″ diameter slabs with 2″ to 3″ speakers. Larger embodiments of stone slabs 101, such as 6″ and 8″×¼″ (or an embodiment of general shape) slabs have been created with wire wrapped perimeter with and without mini speakers to eliminate the resonator. Smaller embodiments of stone slabs 101 have been fashioned into various shapes to fit joints to use in conjunction with the small stone pads for hard to reach joint pain. Another embodiment looks like a headset and includes small stone slabs 101 that set behind the ears for treatment of problems, such as tinnitus and hearing loss. The devices may vary in shapes and sizes to fit the needs of the area of tissue to be treated.

Stone slab 101 may be comprised of stone material, preferably Blue and Silver Pearl Larvikite, Labradorite, Italian Marble, or Black Galaxy. Most of the granite countertops would work with the speaker and/or wire wrap embodiments except for stone originating from sandstone, such as some marbles. Jade works as a medium as well. Stainless steel, PVC and some plastics work well in transferring the signal for the wire wrap embodiment only. A self-adhesive body electrode pad (Tens, EKG, or ECG pad) works well with the dual control box if used with a dummy loads and reduced voltage at 2 μAmps. The body electrode is simply a means by which electricity may flow through wire or a system and into the human body through the skin.

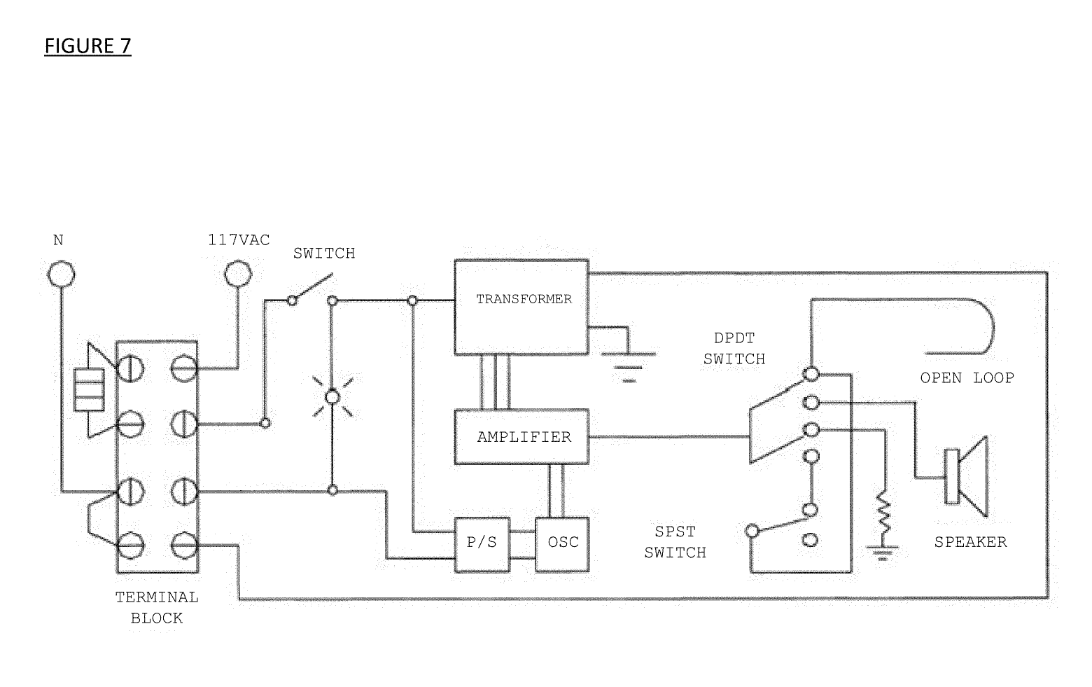

Larvikite is of the Feldspar group and is considered granite. Larvikite has Iron atoms Fe2 and Fe3, which have the same number of neutrons and protons. Fe2 has 2 electrons and Fe3 has 3 electrons in the outer shell. A free electron tries to fill the need for balance in the Fe3 atom and therefore jumps from the Fe2 to the Fe3 atom via the oxygen atom at which time the Fe2 atom draws from the Fe3 atom to balance its electron needs, creating an oscillation of electrons causing a shriller effect, or flashing effect. This is a back and forth bouncing effect of electrons. Therefore, this Granite is a semiconductor with electrons that can be manipulated. By introducing an excess amount of electrons to the medium by means of wave or signal infusion, with proper amplitude, the electrons may be transferred to the stone medium and then transferred to body tissue by means of direct contact with the stone. This blue pearl larvikite stone has metaphysical properties for aiding in grounding the body of negative high frequency energy. By accelerating the electron flow, it may be possible to create a meditative zero point (neutral point) acclamation and astral projection (out of body experience). Larvikite works well for the table device as it will infuse the whole body with an electron rich signal which satisfies the free radicals in the body. Free radicals require negative electrons before they can be neutralized and cleaned up by the lymphatic system. Free radicals that are not satisfied continue to ravage the body tissues for electrons causing sickness and cancers. This process is depicted in FIG. 7. Larvikite has some of the same properties as bone. Labradorite is of the Feldspar group and very similar to Larvikite.

Italian Marble is a granite that contains SI02 (silica and oxygen). These atoms share their valance electrons to form a covalent bond, the SI atom (silica) has 4 electrons and 02 atom (oxygen) has 6 electrons. These electrons can also be manipulated via the oxygen atom by supplying the medium with an excess of electrons. Black Galaxy is of the Feldspar group and considered granite from India. This granite has flecks of bronzite scales of rhombus shapes to aid in the transfer of electrons.

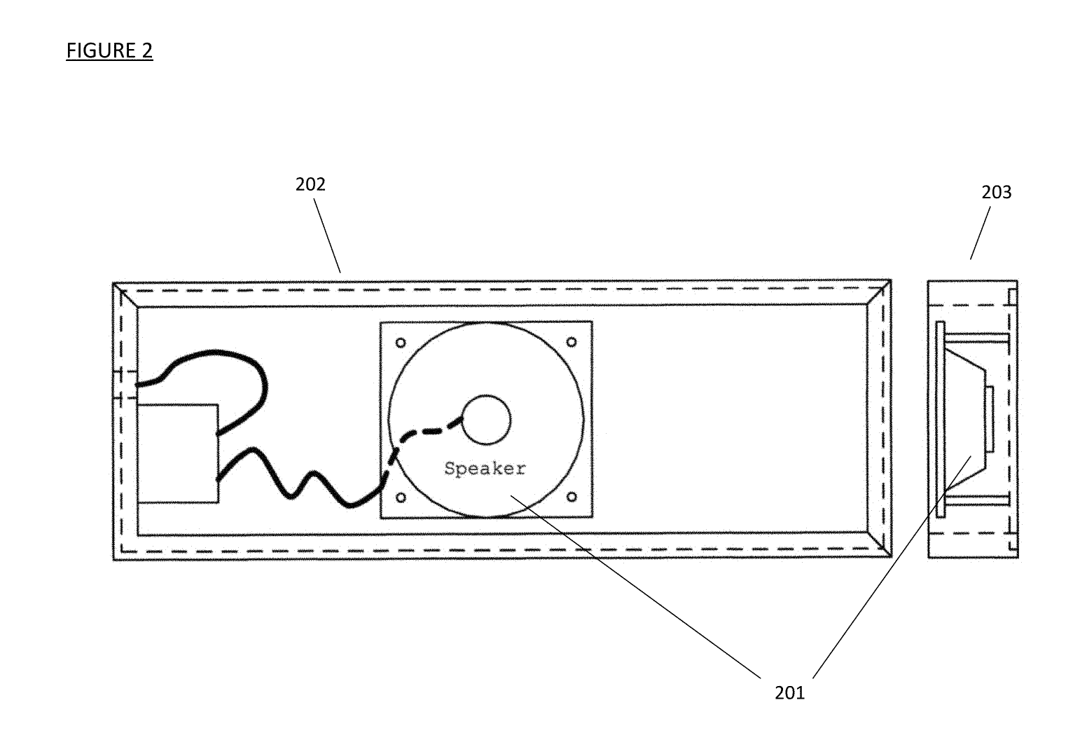

Referring now to FIG. 2, the figure is a diagram of a sound table with a speaker embodiment. The speaker 201 may be positioned on standoffs mid center of the resonator and approximate offset of ⅛″ from top perimeter of the open resonator with a felt pad gasket in which to place the slab upon. 202 is a top view of a speaker embodiment sound table but without the stone slab to show the relative position of the speaker. 203 is a side view of the same embodiment to show depth. Subwoofer may be ⅓ higher wattage than maximum specified amplifier output power from the control box. The device with the speaker embodiment operates on the idea of bombarding the iron atoms Fe2 and Fe3 in the granite with an excess of electrons from the 528 Hz sine wave to promote electron movement. The signal emitted from the medium may be monitored on the oscilloscope with a 10 times probe and an open loop pickup. Electrons are already bouncing from the Fe2 atom to the Fe3 atom via the oxygen atom. One atom has 2 valence electrons and the other has 3 valence electrons in the third or outer subshell. The electrons bounce from one atom to the other trying to balance themselves creating a frequency and a visual Shiller effect in the stone. Sound waves are transferred from the speaker to the stone supplying Iron atoms in the stone medium with an abundance of electrons to be transferred to the body, keeping in mind that electrons are also being carried with the 528 Hz sine wave.

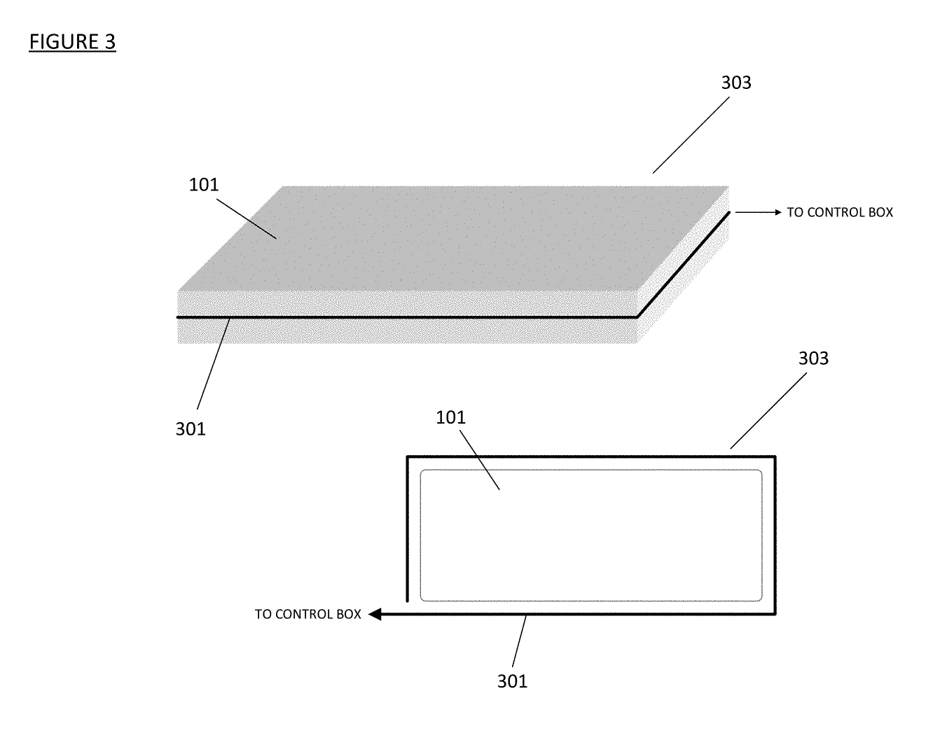

Referring now to FIG. 3, the figure is a diagram 303 of a sound table with a wire wrap embodiment. FIG. 3 has a stone slab 101 and a wire 301. Stone slab 101 may be the same as referred to in FIG. 1. Wire 301 is an open loop wire that may be wrapped around the sides of stone slab 101 and connected to a control box.

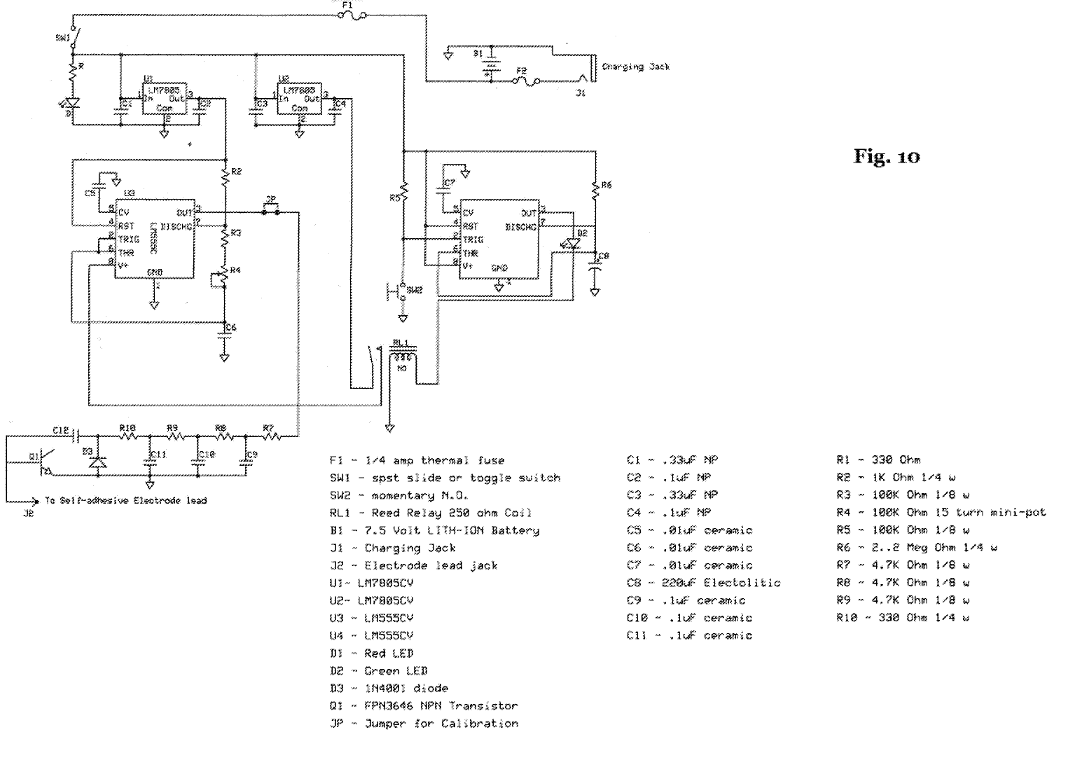

Wire 301 is preferably a 12 AWG stranded copper wire or equivalent (plastic coated) is wrapped around the outside perimeter of the slab and stubbed out for signal interface. The open loop wire wrap embodiment works on the same principal as the speaker embodiment. It may bombard the stone with electrons by means of a dummy load of 8 ohms across the outputs of the control box 1 or 2 (no dummy load across output of control box 3, described below in FIG. 10-13) and a 12 or 14 gauge stranded copper, copper clad, silver or gold or possibly aluminum wire encompassing the outside perimeter of the granite table or pad via a groove in the outside perimeter of the stone device in an open loop fashion. The wire will be connected to the positive side of the 528 Hz. controller and act like an antenna and force electrons onto the table medium by way of an emitted signal and can be monitored on the oscilloscope with an open loop pickup. The wire around the smaller devices is of smaller gauge wire. This technique will create a plane or surface area to emit large amounts of electrons with a natural earth harmonic frequency. Lying on the table provides a total body saturation of electrons as the body will accept the signal and electrons as needed to reduce inflammation and swelling by means acid buffering (neutralizing free radicals) and oxygenation to promote blood flow for pain relief as depicted in FIG. 7. The signal may be observed through an oscilloscope with an open loop pickup placed anywhere on the patient's body. 302 is a top view of the sound table illustrating the path of the wire wrapped around the sound table.

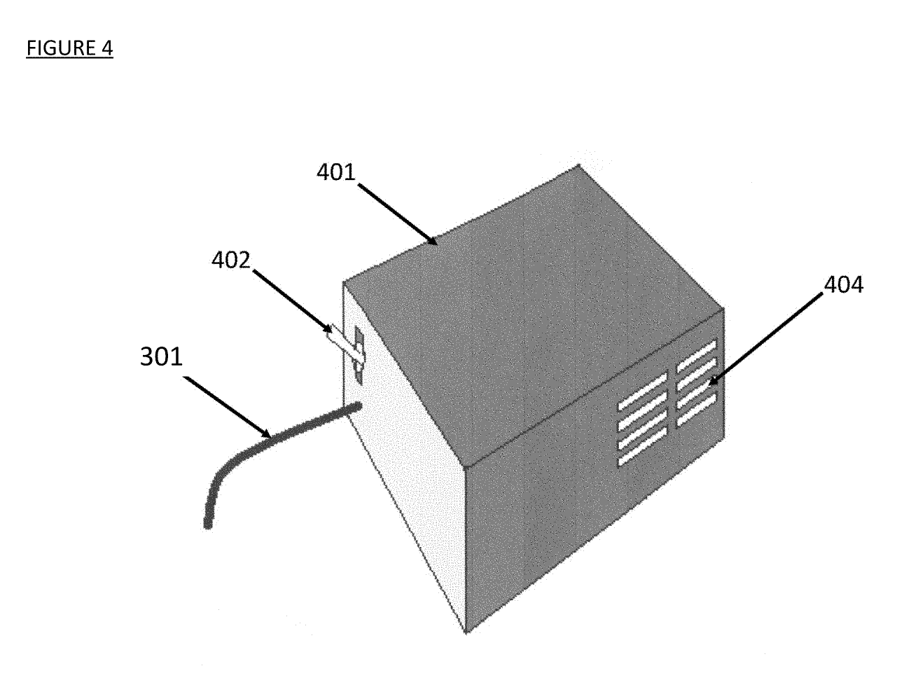

Referring to FIG. 4, the figure is a diagram of a control box. FIG. 4 has a case 401, a switch 402, a wire 301, and vents 404.

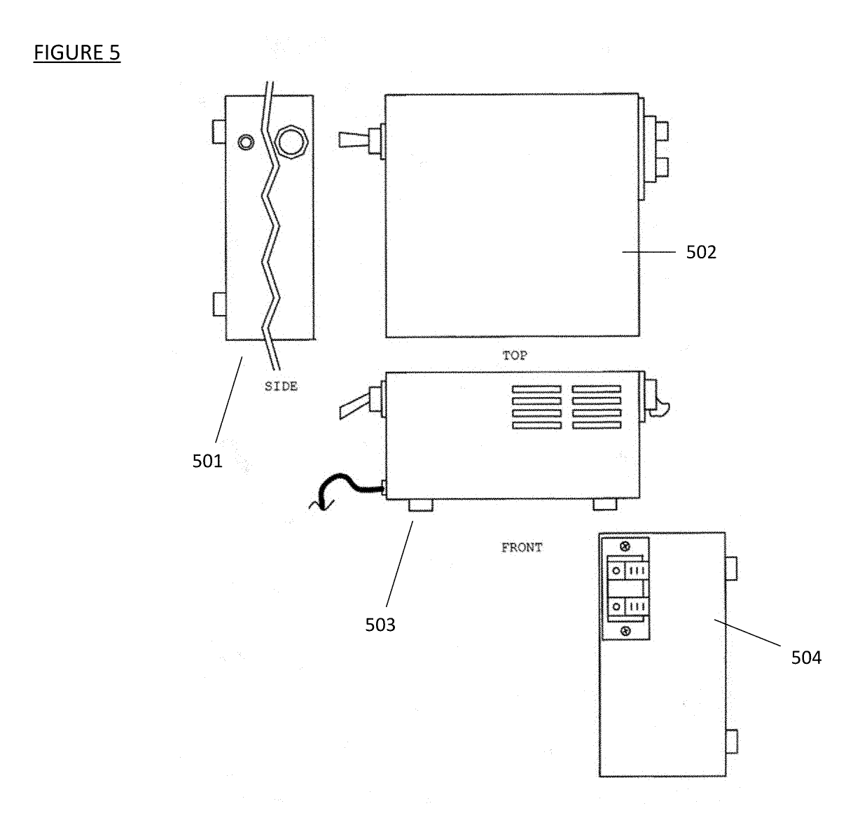

Referring to FIG. 5, the figure is a diagram of the outside of a control box from different angles. 501 is a side view, 502 is a top view, 503 is a front view, and 504 is a rear view.

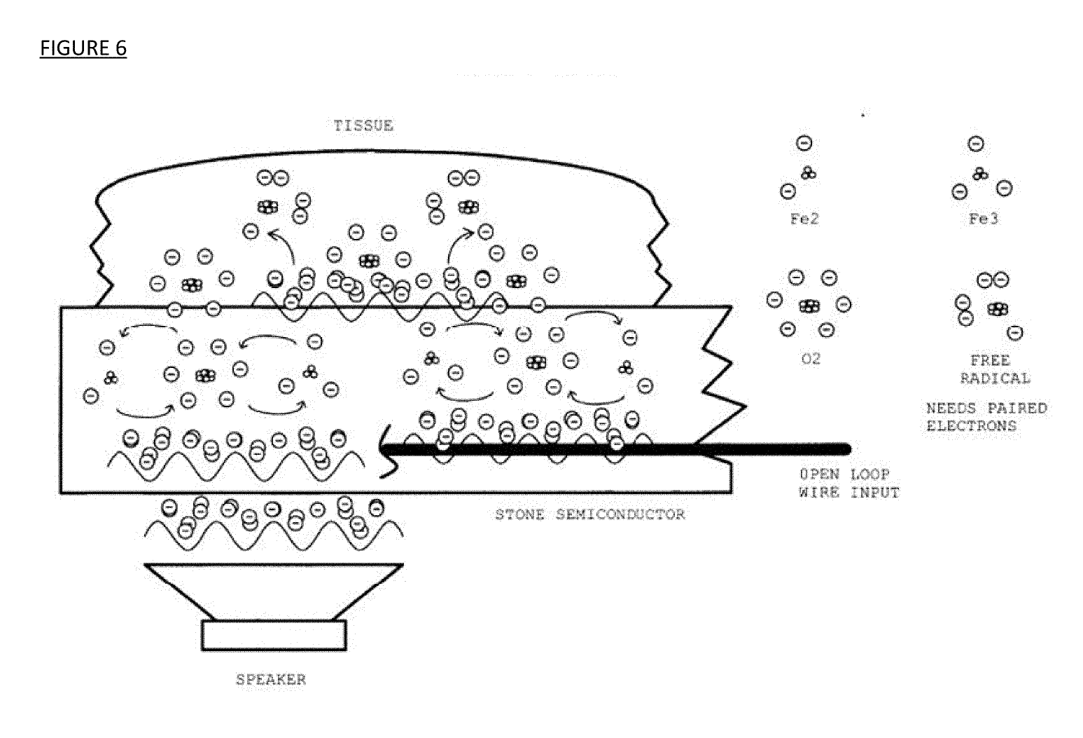

Referring to FIG. 6, the figure is a diagram illustrating electron infusion. The general idea is to oxygenate the body by infusing electrons into the body to create dry cell and buffer acids known as free radicals. Once the free radicals receive enough electrons to be satisfied, they may be neutralized and picked up by the lymphatic system and washed away relieving the body of inflammation and swelling, therefore relieving pain and promoting blood flow.

In FIG. 6, the atomic structures of Fe2, Fe3, O2, and the free radicals are only a rough representation of the atom and its electrons in the outer shell (valence electrons). FIG. 7 does not depict the inner shells and their electrons. The nucleus is also a rough depiction of these atoms as the protons and neutrons are not called out in the drawing but are a rough representation. It is important to note that electron transfer occurs via the outer shell of the atoms.

Referring now to FIG. 7, the figure is a diagram illustrating a configuration 1 (single channel) circuitry for a control box. The control box 1 may be configured to be a single channel controller for the sound infusion table with a speaker and/or open loop wire wrap embodiment consisting of a 110 VAC (Volts Alternating Current) step-down transformer for the voltage required for the 100-watt audio amplifier module and an alternating current (AC) to direct current (DC) voltage converter for the Direct Digital Synthesis Signal Generator model: UDB-10055, which may be set at 528 Hz sine wave with an output of 50mVAC (millivolts ACT) Root Mean Square (RMS or average electrical power) and 0.0 VDC (Volts Direct Current) offset. This control box may produce frequencies from 0.01 Hz to 5 MHz (Mega Hertz), with various wave shapes. The final output of this control box may be preset at 528 Hz sine wave at 0.1 VAC to 0.5 VAC (depending on the device used, with the speaker embodiment or open loop wire embodiment) with 0.00 VDC offset with a rise and fall time of 680 μs (microseconds). This control box may be designed for continuous operation with no user controls other than the On/Off switch. This control box may be configured for continuous duty with modular components, amplifier module with volume control, voltage converter module for the Direct Digital Synthesis Signal Generator module Number UDB-10055, which has adjustable DC offset, amplitude and frequency, with wave shape options. Users control is On/Off switch. This control box is for the Sound Infusion Table with a speaker and/or open loop wire wrap embodiment. For the wire wrap table embodiment, a smaller amplifier module with a dummy load of 4 ohms or 8 ohms, depending on amplifier specifications, may be used in conjunction with an AC to DC voltage converter in place of the step-down transformer. As an option, this unit may be configured with a speaker only, open loop wire wrap only, or both at the same time by means of manual switching by the operator. The open loop circuit may use a dummy load if used alone. When the speaker and open loop circuit is used in conjunction with each other, the open loop circuit may be connected to the positive side of the speaker circuit by means of switching, therefore utilizing the benefits of both infusion techniques.

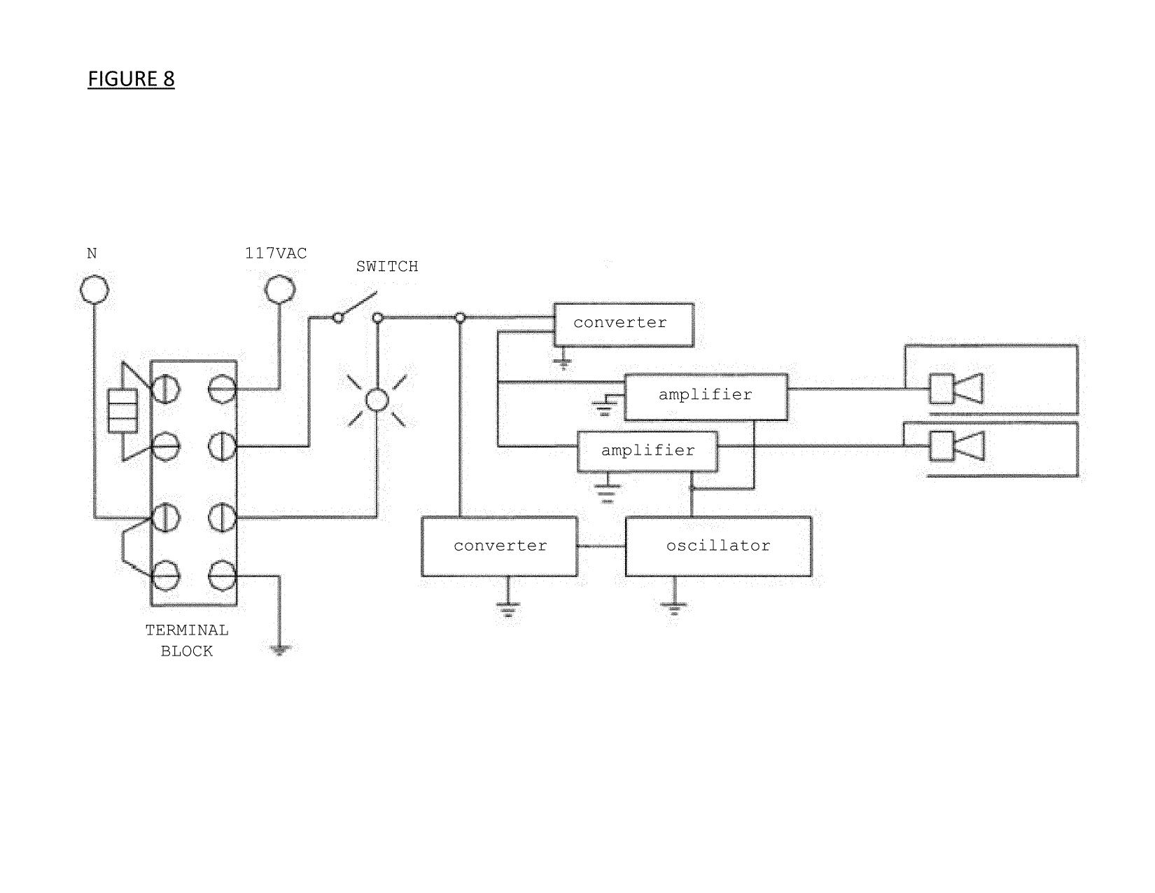

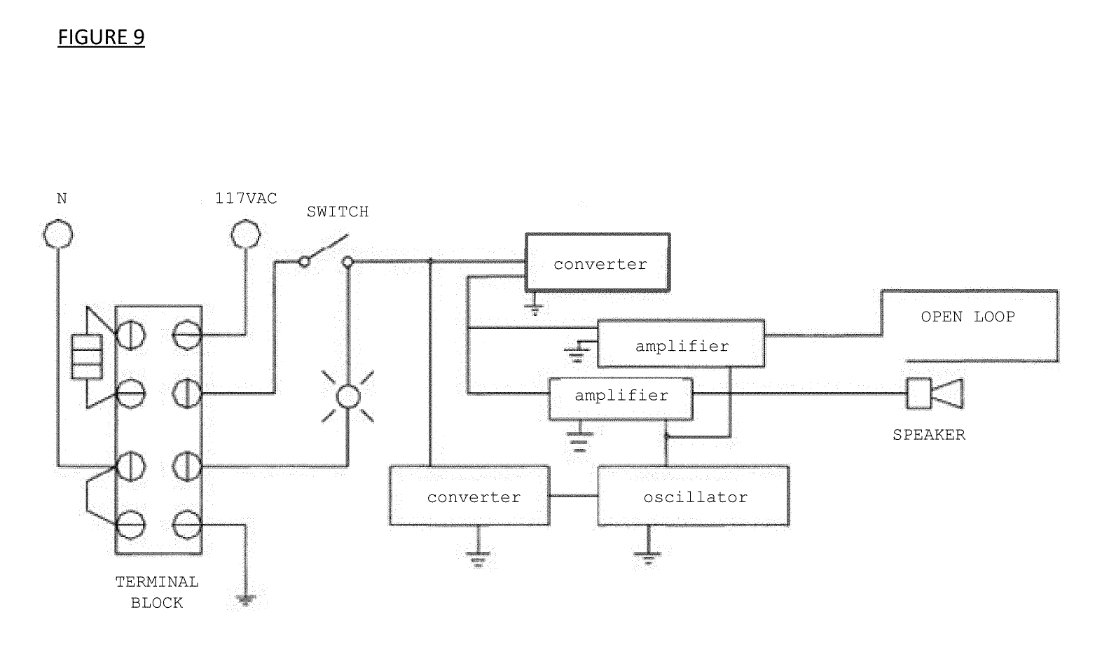

FIGS. 8 and 9 are diagrams illustrating configuration 2 (dual channel) circuitries for a control box. The control box 2 may be configured to be a dual channel 110 VAC controller with an AC to DC converter rather than a transformer for the dual 15-watt audio amplifier modules and a separate AC to DC converter for the Direct Digital Synthesis Generator module which may be set at 528 Hz sine wave at 50 mVAC RMS and 0.000 VDC offset at the output. This control box may be designed for smaller stone pads for localized pain/organ repair control. This control box may work well with a sound infusion table, with one channel for a speaker embodiment and the second channel for the open loop wire wrap embodiment. This control box may be preset for a final output frequency of 528 Hz sine wave with a voltage of 0.1 to 0.5 VAC (depending on the device used, speaker or wire wrap) with a 0.000 VDC offset at a rise and fall time of 680 μs. This control box may reproduce signals from 0.01 Hz to 5 MHz and various wave shapes. For example, an option is the 220 Hz sine wave for COPD (Chronic Obstructive Pulmonary Disease) control. This function may utilize dual stone pads, one for the left side and another for the right side of the lungs. The 936 Hz wave for pineal gland stimulation via a head device may be used. The dual controls may also be used for controlling a foot device or thigh device of the same embodiment. This control box may be configured for continuous duty with modular components, amplifier modules with volume controls, voltage converter module, Direct Digital Synthesis Signal Generator module with adjustable DC offset, amplitude and frequency, with wave shape options. Users control is On/Off switch. Frequencies and wave shapes may be set via the signal generator by a clinician or technician.

Referring now to FIG. 10, this figure is a diagram illustrating control box 3. The control box 3 may be configured as a hand-held battery operated single channel wave infusion frequency control unit designed to operate at 528 Hz sine wave at 124 mVAC at the output. This control unit may be configured to be used with a self-adhesive body electrode (such as Tens, ECG or EKG pad) on a problem area. This control box may be configured with an On/Off switch, red indicator light for main power, and a momentary push button for signal starting with a green indicator light, which may be configured with a ten-minute timer. Most pain relief happens within two to ten minutes. If more time is required, the user may press the start button again for another ten minutes or until pain is relieved, this unit may be shut down by moving the main power switch to the off position. The control box may be configured with no additional user controls. This control unit may be constructed from discrete components and powered by a 7.8 VDC rechargeable Lithium-ion Battery. Two separate 5 VDC regulator chips may be used, one for the oscillator primary power and one for switched main power to pin 8 of the oscillator. The timer may be configured to operate off the battery power to create a high level 5 VDC output at pin 3 to energize a 5 VDC relay for the oscillator pin 8 power, with a momentary push button which would ground the trigger circuit and start the timer. Two 555 timer chips may be used, one to create an oscillator that may be calibrated to produce 528 Hz square wave at pin 3 with a voltage of 1.86 VAC RMS and 4V −4.4 Vp-pAC (peak to peak AC voltage), rise and fall time of 100 μs with a 50% Duty Cycle as read on the oscilloscope. This square wave may be converted latter. The other 555 chip may be used to produce a ten-minute timer. When the momentary start button is pushed, the trigger on the timer goes to ground and begins charging the capacitor and timing begins. The output of the timer goes high and controls a 5 VDC relay which supplies voltage from the secondary regulator to pin number 8 on the oscillator. The square wave signal from the oscillator output is then converted into a sine wave with equal rise and fall time and 50% duty cycle by the use of three RC (resistor, capacitor) filter networks. A diode to ground after the RC networks is used for clamping the circuit to 0.5 VDC from a startup spike of 1.5 VDC. Capacitive coupling at output will bring the DC offset to 0.000V. An NPN (negative collector, positive base, negative emitter) switching transistor is used on the output utilizing the base/emitter junction only, this utilizes the transistor junction as a zener diode and clamps the circuit to a maximum startup spike of 0.2 VDC/AC to 0.5 VDC/AC. the output of this unit will be 0.124 VAC RMS at 528 Hz. Sign wave at 1 μAmp. (E/R=I, E=0.124 V/skin resistance=100K Ohms, 124/100K=1μAmp). The voltage ranges mentioned for the single channel battery powered hand held control unit are specifications used in construction and calibration of the said controller to produce a single specified output.

The control units may be calibrated with a Keysight Technologies™ trademarked Oscilloscope and a Fluke™ Multi-Meter manufactured by Fluke Manufacturing. These control units may be designed with fixed values to create the most efficient wave to produce electrons. Sound waves such as 528 Hz sine waves have been found to produce electrons that may drift from trough to trough along the wave and allow utilization of these electrons by means of direct contact with the wave. If the amplitude of the wave is too high, the electrons may drop into the troughs and pool, rendering them unable to be transferred from the wave to the medium or the patient.

The circuitry of control box 1 and 2 are comprised of modular components which creates a signal and runs it through an amplifier to the devices, demonstrated in FIGS. 10, 11, and 12.

The circuitry of control box 3 (as per schematic diagram drawing FIG. 13); battery operated unit uses standard voltage regulator components with capacitors for stabilization, one regulator for powering up the oscillator's primary circuit and one for the oscillator's main switched power via a relay (RL1) activated by the timer. The oscillator and timer are comprised of two 555 timer chips with standard biasing configuration to create a 528 Hz oscillator (left side of drawing) and standard biasing configuration for creating a timer (right side of drawing). The output of the oscillator is a square wave and is converted to a sine wave with a resistor and capacitor filtering to round off the signal and is considered to be a standard RC network. The unique addition to this circuit is the clamping circuit on the tail end of the output (J2), an NPN transistor (Q1) base/emitter junction is used as a Zeiner diode with the collector terminated, this was added due to the unavailability of a 0.2 volt Zeiner diode. This clamps the circuit voltage to 0.2 volts and is a very unconventional way of using a transistor. To prevent over voltage on the transistor junction a primary clamp was installed by means of a diode (D3) before the coupling capacitor (C12) to clamp any voltage spikes over 0.5 volts. I also consider the overall design configuration and operation of this unit to be unique.

This invention is further illustrated by the following examples, which are not to be construed in any way as imposing limitations upon the scope thereof. On the contrary, it is to be clearly understood that resort may be had to various other embodiments, modifications, and equivalents thereof, which, after reading the description herein, may suggest themselves to those skilled in the art without departing from the spirit of the present invention.

### Example 1: Effect of Harmonic Frequency Stimulation on Right Ear

Materials and Methods: A middle aged woman had deafness in her right ear, resulting from a severe impact sustained on the right side of the head at twelve years of age. Past magnetic resonance imaging (MRI) scans have shown non-active brain tissue on the right side of the head resulting in symptoms of tinnitus. The non-active tissue moved down in the past years, resulting in new activity on the right side of the head at ear level with no auditory change but still having “ringing, buzzing, thumping sounds.”

Two treatment sessions were done in a span of three days. Treatments took place on the Sound Infusion Table with the speaker embodiment with control box 1 (110 VAC single channel 100-watt output). Table is of Blue Pearl Larvikite slab approximately 2′×4′×1⅛″ in size. The patient lay down with back on slab (shirt, pants and socks on), knees together and bent in an upward position creating the pelvic tilt position on the Table, with feet flat on slab (one foot in each corner), with head on small pillow for comfort and arms at the patient's side. First day Dec. 19, 2014 was a 15-minute session. Next session took place on Dec. 21, 2014 for 20 minutes.

Results: Hearing increased to a higher level of acuteness and less tinnitus symptoms after each session on the Sound Infusion Table until maximum hearing was achieved and tinnitus symptoms were gone. This was a progressive healing progress and was achieved in two sessions in three days at 15-20 minutes per session. An ear test conducted about three weeks after the last treatment session showed no auditory loss in the right ear. This is a possible cochlea nerve fiber repair. With ionic changes in the stria vascularis of the cochlea by means of oxygenation by the sound infusion device, possible degradation of mutations in the Kir4.1 channel can be achieved, restoring the cochlea to proper potassium and voltage levels. It is possible that the fluid in the middle ear was thickened or calcium build-up developed on the malleus, incus, and stapes assembly, reducing their function. It is possible the sound infusion device broke up the calcium and excited the lymphatic system to clean and return the fluid to its original viscosity.

### Example 2: Effect of Harmonic Frequency Stimulation on Back Pain

Materials and Methods: A middle aged man with an extra disc in the sacroiliac region has resulting pain that requires morphine. Past burning has destroyed some nerves. The patient arrived using a cane as a main support with a pain level of six while using morphine. Five treatment sessions were done over a span of thirteen days. Many treatments took place on the Sound Infusion Table with the speaker embodiment with control box 1 (110 VAC single channel 100-watt output). Table is of Blue Pearl Larvikite slab approximately 2′×4′×1⅛″ in size. The patient lay down with back on slab (shirt, pants and socks on), knees together and bent in an upward position creating the pelvic tilt position on the Table, with feet flat on slab (one foot in each corner), with head on small pillow for comfort and arms at the patient's side.

Jan. 13, 2015 low right back pain with a starting pain level of 6/10, 25 minutes on Table and pain reduction was three points.

Jan. 16, 2015 good pain reduction from last session, reported smaller amount of morphine use. Starting pain level today is 4/10, 20 minutes on the Table and pain reduction was three points.

Jan. 18, 2015 much more active, creating pain to a level of 6/10, 10 minutes on Table and pain reduction was three points.

Jan. 22, 2015 starting pain level 5/10, 20 minutes on Table and pain reduction was three points.

Jan. 26, 2015 starting pain level is 5/10, 20 minutes on the Table and pain reduction was three points. Patient reported himself and his wife were very pleased with the results. Patient did not return for further sessions.

Results: The patient enjoyed pain relief without the use of a cane or morphine, or a very small dose of morphine when needed.

### Example 3: Effect of Harmonic Frequency Stimulation on Chronic Myalgia

Materials and Methods

Sep. 13, 2014 Diagnosis: Deep Vein Thrombosis and chronic Myalgia in lower calf muscles. Patient was using a walker with a pain level of 8/10. A smaller device with a speaker embodiment with control box 1 as a driver was placed under each calf muscle with clothing on for 25 minutes to bring the pain level to 0/10.

Sep. 14, 2014 10:00 am pain level 3/10, 12 minutes with same device to bring pain level to 0/10. 3:00 pm pain level of 5/10 from walking, 30 minutes was used on same device to bring pain level to 0/10.

Sep. 15, 2014 5:00 pm pain level of 7/10 from 1 mile walk, calf muscles are hard. After 35 minutes on small device, calf muscles feel soft and pain reduced to 0/10.

Sep. 16, 2014 3:10 pm pain level 5/10, 30-minute session to reduce pain to 3/10.

Sep. 17, 2014 9:00 am no need for device, very low pain level. 4:00 pm same report.

Sep. 18, 2014 2:10 pm pain level 10/10, A 30-minute session on a smaller device softened calf muscles and brought the pain level down to 4/10.

Sep. 19, 2014 11:25 am pain level of 7/10, 25 minutes with 4″ pad with speaker embodiment with control box 1 reduced pain to a level 3/10.

Sep. 20, 2014 9:55 am pain level of 3/10, 12 minutes on a small device brought the pain level down to 0/10.

Sep. 21, 2014 10:00 am patient reports very little pain. no need for session.

Sep. 28, 2014 6:28 pm pain level at a pain level of 3/10, 20 minutes on small device brought the pain level down to 0/10.

Oct. 16, 2014 10:00 pm calf muscles hard and stiff with a pain level of 5/10, 30-minute session brought the pain level down to 2/10 at 10:30 pm. 10:45 pm pain level down to 0/10.

Oct. 17, 2014 11:45 am pain level of 3/10, a 15-minute session brought the pain level down to 0/10.

Results: With toning techniques patient enjoys life without myalgia pain in the calf muscles. No further sessions were needed.

While preferred and alternate embodiments have been illustrated and described, as noted above, many changes can be made without departing from the spirit and scope of the sound infusion device and method. Accordingly, the scope of the sound infusion device and method is not limited by the disclosure of these preferred and alternate embodiments. Instead, the scope of the sound infusion device and method should be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. §112 ¶6. In particular, the use of “step of” in the claims herein is not intended to invoke the provisions of U.S.C. §112 ¶6.

What is claimed is:

1. An apparatus for treating tissue with harmonic frequency by direct contact, comprising:
a table having an upper portion, a border portion, and a base portion, the table being adaptive to receive a signal and configured to receive a tissue portion of a patient;
a sound wave emission means; and
a control box having an output that is configured to receive the sound wave emission means, wherein the control box is configured to generate the signal and to send the signal to the table.

2. The apparatus of claim 1, wherein the table comprises a pad that is portable and configured to treat localized areas within the tissue portion of the patient.

3. The apparatus of claim 1, wherein the upper portion of the table comprises a stone material.

4. The apparatus of claim 1, wherein the upper portion of the table is made of a Blue and Silver Pearl Larvikite, Labradorite, Italian Marble, Black Galaxy, granite, or jade material.

5. The apparatus of claim 1, wherein the control box is configured to be controllable by a hand held and battery operated device.

6. The apparatus of claim 1, wherein the sound emission means further comprises a speaker configured to send sounds waves and iron atoms to the upper portion of the table, wherein an abundance of iron atoms are transferred to the tissue portion of the patient.

7. The apparatus of claim 1, wherein the sound emission means further comprises an open loop wire wrap configured to send sounds waves and iron atoms to the upper portion of the table, wherein an abundance of iron atoms are transferred to the tissue portion of the patient.

8. The apparatus of claim 1, wherein the signal has a harmonic frequency between 100 hertz and 750 hertz.

9. The apparatus of claim 1, wherein the upper portion of the table serves as a medium to transfer the signal from an open loop wire wrap, speaker, or both an open loop wire wrap and a speaker.

10. The apparatus of claim 1, wherein the wire wrap is in direct contact with the upper portion of the table and positioned between the upper portion and the border portion.

11. The apparatus of claim 1, wherein the control box comprises an adjustable direct current (DC) offset control, amplitude and frequency control, wave shape control, and an on/off switch control.

12. The apparatus of claim 1, wherein the control box is configured to be a single channel controller having a circuit structure comprising:
a speaker having an electrical connection to a double pole double throw (DPDT) switch;
an amplifier connected in series with the DPDT switch;
a transformer connected in series with the amplifier and a terminal block;
an oscillator connected in series with the amplifier and the terminal block; and
a voltage source.

13. The apparatus of claim 1, wherein the control box is configured to be a multi-channel controller having a circuit structure comprising:
a plurality of speakers connected in series with a plurality of amplifiers;
a first converter connected in series with the plurality of amplifiers;
an oscillator connected in series with the plurality of amplifiers;
a second converter connected in series with the oscillator and the first converter;
a terminal block connected in series with the first converter and the second converter; and
a voltage source connected in series with the terminal block.

14. The apparatus of claim 1, wherein the control box is configured to be a single channel controller having a circuit structure comprising:
an open loop wire wrap having an electrical connection to a double pole double throw (DPDT) switch;
an amplifier connected in series with the DPDT switch;
a transformer connected in series with the amplifier and a terminal block;
an oscillator connected in series with the amplifier and the terminal block; and
a voltage source.

15. The apparatus of claim 1, wherein the control box is configured to be a multi-channel controller having a circuit structure comprising:
a plurality of speakers and open loop wire wraps connected in series with a plurality of amplifiers;
a first converter connected in series with the plurality of amplifiers;
an oscillator connected in series with the plurality of amplifiers;
a second converter connected in series with the oscillator and the first converter;
a terminal block connected in series with the first converter and the second converter; and
a voltage source connected in series with the terminal block.

16. The apparatus of claim 1, wherein the control box is a battery operated unit having a circuit structure comprising:
an NPN transistor connected in series with a first capacitor;
a plurality of resistors connected in series, the first capacitor connected in series with the plurality of resistors;
a diode connected in series with the first capacitor;
a second capacitor connected in parallel with the diode and in series with the plurality of resistors;
a third capacitor connected in parallel with the second capacitor and in series with the plurality of resistors; and
a fourth capacitor connected in parallel with the third capacitor and in series with the plurality of resistors.

17. A method for treating a tissue portion of a patient, the method comprising the steps of:
applying a table or pad directly to the tissue of the patient;
adjusting a control box to a desired frequency; and
sending a signal from the control box to the tissue portion of the patient.

18. The method of claim 17 further comprising the step of turning on the control box and setting the desired frequency to 528 hertz prior to the applying step.

19. The method of claim 17, wherein the applying the table or pad is administered for at least 2 minutes.

20. The method of claim 17, wherein the signal is communicated through an open loop wire wrap or a speaker.
